(19) United States
(12) Patent Application Publication
(10) Pub. No.: US 2025/0363065 A1
(43) Pub. Date: Nov. 27, 2025

(54) SWITCHING SYSTEM-ON-A-CHIP

(71) Applicant: MaxLinear, Inc., Carlsbad, CA (US)

(72) Inventors: Sridhar Ramesh, Carlsbad, CA (US); Sheng Ye, Carlsbad, CA (US); Masoud Koochakzadeh, Carlsbad, CA (US); John Andrew Guckenberger, Carlsbad, CA (US); Curtis Ling, Carlsbad, CA (US)

(73) Assignee: MaxLinear, Inc., Carlsbad, CA (US)

(21) Appl. No.: 19/216,597

(22) Filed: May 22, 2025

Related U.S. Application Data
(60) Provisional application No. 63/650,402, filed on May 22, 2024.

(51) Int. Cl. G06F 13/20

(52) U.S. Cl. CPC G06F 13/20; G06F 2213/40

(57) ABSTRACT

Technology is disclosed for a system. The system may include a system-on-chip (SoC) including one or more physical media dependent (PMD) devices, in which the one or more PMD devices are associated with one or more digital signal processors (DSPs), in which the one or more DSPs operate one or more crossbar switches; a central crossbar switch facilitating communication between the one or more DSPs; and a control unit operable to manage a configuration of the one or more crossbar switches based on a lookup table, in which the lookup table facilitates data routing between an input and an output.

### RELATED APPLICATION

This application claims the benefit of U.S. Provisional Application No. 63/650,402, filed May 22, 2024, the disclosure of which is incorporated herein by reference in its entirety for all purposes.

The examples discussed in the present disclosure are related to a switching system-on-a-chip.

### BACKGROUND

Network switches may be used in data communication systems to route information between different parts of a network. Traditional network switches operate primarily in the electrical domain, using complex arrangements of digital signal processors (DSPs) and application-specific integrated circuits (ASICs) to manage data routing. Many conventional systems use substantial power to operate and face challenges in scaling, latency, and flexibility.

Optical switching technologies may offer power efficiency and speed but may be generally less flexible and slower to reconfigure compared to their electronic counterparts. Such optical switches often convert optical signals to electrical for processing, then back to optical for transmission, incurring significant power losses and operational inefficiencies. Particularly in configurations optimized for static routing use cases such as large data centers and cloud services, many technologies still struggle with the inherent trade-offs between power consumption, switching speed, and configurational flexibility.

### SUMMARY

A system may include a system-on-chip (SoC) including one or more physical media dependent (PMD) devices, in which the one or more PMD devices are associated with one or more digital signal processors (DSPs), in which the one or more DSPs operate one or more crossbar switches; a central crossbar switch facilitating communication between the one or more DSPs; and a control unit operable to manage a configuration of the one or more crossbar switches based on a lookup table, in which the lookup table facilitates data routing between an input and an output.

A method may include: receiving, at a first stage, a data signal, in which the first stage includes one or more PMD devices including one or more digital signal processors (DSPs) that operate a first set of one or more crossbar switches. The method may include transmitting, from the first stage to a second stage, the data signal, in which the first stage is operatively connected to the second stage via the first set of one or more crossbar switches. The method may include determining, at the one or more DSPs, a first connection path between the first stage and the second stage using a lookup table.

### BRIEF DESCRIPTION OF THE DRAWINGS

So that the manner in which the above recited features of the present disclosure can be understood in detail, a more particular description of the disclosure, briefly summarized above, may be had by reference to examples, some of which are illustrated in the appended drawings. It is noted, however, that the appended drawings illustrate only some aspects of this disclosure and the disclosure may admit to other equally effective examples.

To facilitate understanding, identical reference numerals have been used, where possible, to designate identical elements that are common to the figures. It is contemplated that elements and features of one example may be beneficially incorporated in other examples without further recitation.

FIG. 1 illustrates a schematic of an exemplary switch system;

FIG. 2 illustrates a schematic of an exemplary switch system;

FIG. 3 illustrates a schematic of an exemplary switch system;

FIG. 4 illustrates a schematic of an exemplary switch system;

FIG. 5 illustrates an example digital signal processor;

FIG. 6 illustrates an example digital signal processor;

FIG. 7 illustrates an example of leaf-switch to spine-switch inter-connectivity;

FIG. 8 illustrates example architecture for a switch with radix expansion.

FIG. 9 illustrates an example process flow for data signal transmission;

FIG. 10 illustrates an example communication system;

FIG. 11 illustrates a diagrammatic representation of a machine in the example form of a computing device within which a set of instructions, for causing the machine to perform any one or more of the methods discussed herein, may be executed.

### DETAILED DESCRIPTION

The present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single example, but other examples are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure.

As used herein, the singular form of “a”, “an”, and “the” include plural references unless the context clearly dictates otherwise. As used herein, the statement that two or more parts or components are “coupled” shall mean that the parts are joined or operate together either directly or indirectly (i.e., through one or more intermediate parts or components, so long as a link occurs). As used herein, “directly coupled” means that two elements are directly in contact with each other. As used herein, “fixedly coupled” or “fixed” means that two components are coupled so as to move as one while maintaining a constant orientation relative to each other. As used herein, “operatively coupled” means that two elements are coupled in such a way that the two elements function together. It is to be understood that two elements “operatively coupled” does not require a direct connection or a permanent connection between them. As utilized herein, “substantially” means that any difference is negligible, or that such differences are within an operating tolerance that are known to persons of ordinary skill in the art and provide for the desired performance and outcomes as described in one or more examples herein. Descriptions of numerical ranges are endpoints inclusive.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality). Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

Examples described as being implemented in hardware should not be limited thereto, but can include examples implemented in software, or combinations of software and hardware, and vice-versa, as will be apparent to those skilled in the art, unless otherwise specified herein. In the examples described herein, an example showing a singular component should not be considered limiting; rather, the invention is intended to encompass other examples including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The examples described herein include a switch architecture that may integrate crossbar functionalities within optical transceivers to achieve high data throughput while reducing power consumption and improving scalability in network systems. With the resurgence of circuit switching, particularly in configurations optimized for static routing use cases such as large data centers and cloud services, the examples herein address the use for more efficient and scalable switching solutions.

Some examples described herein introduce an approach to network switch design, leveraging the capabilities of optical transceivers integrated with an 8×8 crossbar functionality. Such integration facilitates direct routing within the optical domain, reducing energy-intensive signal conversions and thereby enhancing overall power efficiency.

Some examples include an integrated crossbar in optical transceivers where each, some, or at least one, transceiver incorporates a crossbar (e.g., an 8×8 crossbar) that allows for flexible routing between any input and output lanes directly within the transceiver, minimizing the latency and power usage associated with traditional switching mechanisms. The switch architecture may be designed to be highly scalable, enabling straightforward expansion by adding more transceivers and crossbars without significant increases in power consumption or complexity. In some examples, the switch may be configured with either passive crossbars, using Micro-Electro-Mechanical Systems (MEMS) technology for ultra-low power operation, or active crossbars that utilize existing digital signal processor (DSP) chips, providing a balance between performance and energy efficiency. In some examples, despite being optimized for static routing, the system may incorporate features for dynamic reconfiguration with minimal latency, utilizing advanced control protocols and real-time signal processing capabilities within the transceivers.

Accordingly, the switch system of the examples described herein represents an advancement in network technology, offering an optimal solution for modern data centers and cloud networks where high efficiency, scalability, and low latency are used. The examples described below not only address limitations of both electronic and optical switching technologies but also introduce a new standard for network architecture design, particularly advantageous for environments demanding high throughput and energy efficiency.

A system may include a system-on-chip (SoC) including one or more physical media dependent (PMD) devices (e.g., optical transceivers or electrical transceivers), in which the one or more PMD devices may be associated with one or more DSPs. The one or more DSPs may operate one or more crossbar switches. The system may include a central crossbar switch which may facilitate communication between the one or more DSPs. The system may include a control unit. The control unit may manage a configuration of the one or more crossbar switches based on a lookup table. The lookup table may facilitate data routing between an input (e.g., any input) and an output (e.g., any output).

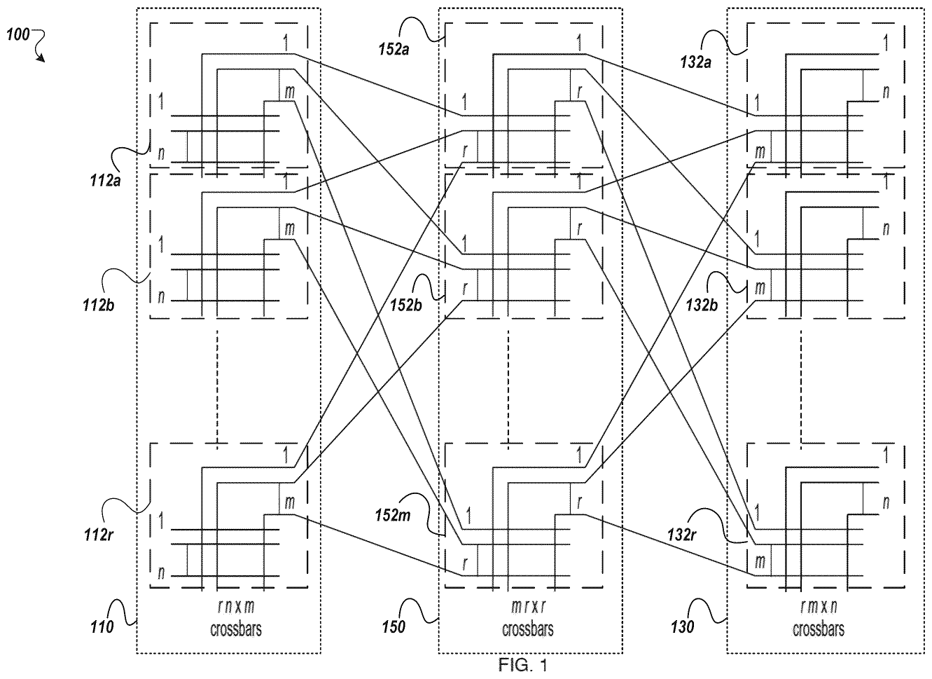

FIG. 1 illustrates an exemplary switch system 100 (hereinafter “switch 100”). Switch 100 may include a three-stage network configuration, which may be used to facilitate scalable, non-blocking switching capabilities within data networks. The switch 100 may facilitate a non-blocking path between an input and an output.

Switch 100 may include input stage 110 and output stage 130. Both left (i.e., input stage 110) and right (i.e., output stage 130) portions of switch 100 may include a series of vertical crossbars labeled as e.g., r n×m crossbars and r m×n crossbars. Stage 110 may include a series of vertical crossbars including crossbar 112a, crossbar 112b, and crossbar 112r. Output stage 130 may include a series of vertical crossbars including crossbar 132a, crossbar 132b, and crossbar 132r.

For input stage 110, the series of r vertical crossbars may be the input stages of switch 100's network, where n may be the number of lanes in each crossbar and m may be the number of switches in each stage. The crossbars at this stage may route traffic from the inputs (which may number the product of r multiplied by n) to the middle stage crossbars, facilitating different path selection for incoming data packets.

Central stage 150 may include a series of crossbars labeled as m r×r crossbars (e.g., crossbars 152a, 152b, 152m). This central stage 150, where m may refer to the number of inputs per crossbar from the previous stage and r may indicate the number of outputs per crossbar leading to the next stage, may facilitate further routing of the traffic received from the input stage crossbars to the appropriate output stage crossbars. Central stage 150 is advantageous for maintaining the non-blocking nature of the network by effectively distributing the traffic across multiple paths.

For output stage 130, the series of r vertical crossbars may the output stages of switch 100's network, where m may be the number of output lanes in each crossbar and n may be the number of switches in each stage. The crossbars at this stage may route traffic from the middle crossbars to the outputs (which may number of the product of r multiplied by n), facilitating different path selection for outgoing data packets.

Switch 100 may ensure that there is a path available from an input to an output, assuming no single point of saturation. This feature may be advantageous for high-performance computing and data center environments where downtime or data bottlenecks may be unacceptable. Moreover, switch 100 configuration may allow the network to scale efficiently by adding more crossbars at the different stages. The modular nature of the switch 100 may facilitate expansion of network capacity without an overhaul of the existing infrastructure.

For example, multiple paths between inputs and outputs may allow the network to reroute traffic dynamically in case of a failure or excessive traffic on any single path. This flexibility may enhance the reliability and robustness of the network. The layout may optimize the use of interconnects by evenly distributing the load across available paths, thereby minimizing the chances of congestion and maximizing throughput.

Switch 100 may allow for the efficient management of data flows across a large-scale network. Such configuration supports high data throughput demands while maintaining low latency and high reliability, which may be advantageous for modern data centers and cloud computing environments. Switch 100 may use such architecture to provide a scalable and flexible switching solution, ensuring optimal performance under varying network loads and conditions.

The one or more of the input stage 110 or the output stage 130 may include one or more PMDs (e.g., optical transceivers or electrical transceivers) that may be connected directly to one or more DSPs without external interfacing.

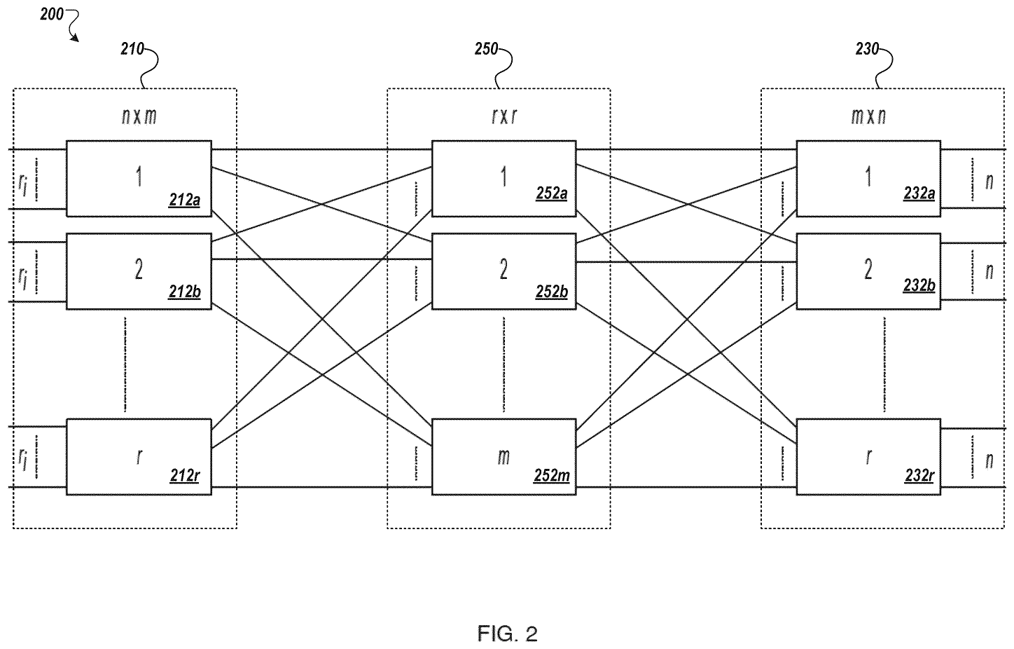

As shown in FIG. 2, switch 200 may correspond to an example of the switch 100, shown in FIG. 1. As shown in FIG. 2, switch 200 may include a number of functional components—input stage 210, middle stage 250, and output stage 230. The input stage 210 may include r n×m crossbars in which n may be the number of input lines per crossbar and m may be the number of switches per crossbar. The crossbars 212a, 212b, 212r may be used for routing inputs to the middle stage 250. The middle stage 250 may include m r×r crossbars where m may be the number of crossbars in this stage, designed to handle connections from the input stage crossbars (e.g., crossbars 212a, 212b, 212r, or the like) to the output stage crossbars (e.g., crossbars 232a, 232b, 232r, or the like). The output stage 230 may include r m×n crossbars in which m may be the number of output lines per crossbar and n may be the number of switches per crossbar. The crossbars at the output stage 230 (e.g., crossbars 232a, 232b, 232r) may route data from the middle stage 250 to the outputs.

The middle stage crossbars (e.g., crossbars 252a, 252b, 252m, or the like) may facilitate the non-blocking feature of switch 200 network by efficiently managing multiple data paths and allowing flexible data routing between inputs and outputs. Such non-blocking network design may facilitate a non-blocking network configuration, which may be used for the high-throughput standards of modern data centers and cloud computing infrastructures where switch 200 may be deployed. Non-blocking paths may use a path that may be available for traffic between inputs and outputs, which may maintain network performance under high load conditions.

Switch 200 may be expanded by increasing the number of crossbars in the stages, which aligns with the scalability features of switch 100. Such flexibility may support gradual network growth without reengineering.

The crossbars may have any suitable dimensions. In one example, the crossbar may be an 8×8 crossbar switch. In another example, the crossbar may be a 64×64 crossbar switch.

Modularity in the design may allow for isolated upgrades and maintenance, which may minimize downtime and enhance overall system reliability. Switch 200 may support efficient traffic management by distributing the load evenly across paths, reducing the likelihood of congestion and bottlenecks. Such efficient distribution may be used in data-intensive applications such as high-performance computing, multimedia transmission, and large-scale data processing, where switch 200 may be used.

FIG. 200 illustrates the architecture that allows the switch to handle vast amounts of data with high efficiency and low latency. The modular approach not only simplifies maintenance and upgrades but also aligns with the demands for energy efficiency and performance optimization in enterprise and cloud environments. FIG. 200 aids in understanding the flow of data through switch 100 network and underscores the practical implementation of such a network.

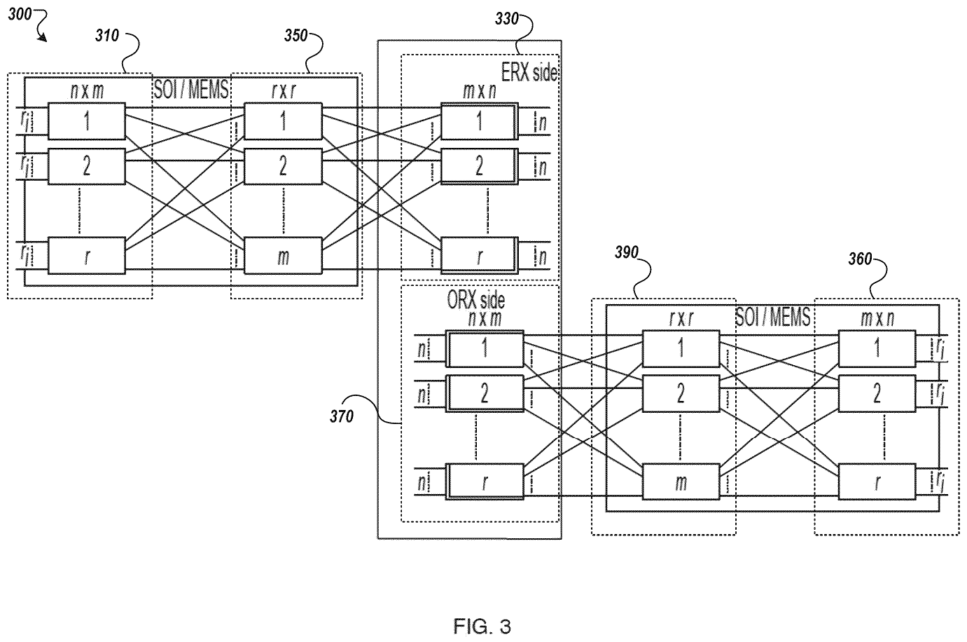

Referring now to FIG. 3, in conjunction with FIGS. 1 and 2, FIG. 3 depicts a schematic of switch 300. As shown switch 300 includes switch elements having Silicon on Insulator (SOI) and MEMS technology, specifically designed for switch 300. Switch 300 extends the concepts depicted in FIGS. 1 and 2, incorporating detailed functionality for emitter (ERX) and receiver (ORX) sides to optimize the flow of data through different segments of the network.

Input stage 310 and output stage 330 denote the input/output stages with crossbars labeled as n×m and m×n. These labels indicate the number of input lines (n) and the number of crossbars (m) per crossbar for input stage 310 and the number of crossbars (n) and the number of output lines (m) per crossbar for output stage 330. Similarly, input stage 360 and output stage 370 denote the input/output stages with crossbars labeled as m×n and n×m, respectively. The middle stage 350 may connect the input stage 310 and the output stage 330. The middle stage 390 may connect the input stage 360 and the output stage 370.

The use of SOI/MEMS at these stages enhances the switching capabilities by reducing power consumption and operational delays, which may be used in high-speed data processing and transmission environments. As shown, switch 300 includes a stage with ERX and ORX blocks. The ERX and ORX blocks may be equipped with crossbars labeled m×n and n×m, which may reflect the capacity for routing traffic between input and output crossbars.

In some examples, the switch 300 may include one or more passive crossbars which may use MEMS to facilitate reduced power when compared to a baseline (e.g., when MEMS is not used).

The ERX side may facilitate outbound data (emission/transmission), while the ORX side may facilitate inbound data (reception), allowing specialized processing and enhanced management of data traffic flows. Switch 300 may include connectivity and data routing features including comprehensive linkage, which may ensure extensive interconnectivity between input and output stage crossbars. Such arrangement may support a non-blocking network operation, advantageous for maintaining continuous data flow in systems requiring high availability.

In some examples switch 300 may dynamically adjust to traffic conditions, benefiting from the distinct functionalities assigned to the ERX and ORX sides. Such configuration may aid in minimizing congestion and optimize the handling of diverse data types. As shown in FIG. 3, integration of SOI/MEMS not only optimizes physical attributes including space and power but may also enhance the electronic properties of the network components, leading to faster response times and greater durability under high traffic conditions.

Moreover, the separation between ERX and ORX sides may facilitate targeted processing of traffic, reducing bottlenecks and improving overall network efficiency. This segmentation may be effective in environments with asymmetric traffic patterns, where the volume of inbound and outbound data might vary significantly. Switch 300 may facilitate scalability by adding more crossbars or adjusting the current setup to handle increased traffic volumes or to meet new operational demands. Such flexibility is advantageous for future-proofing the network infrastructure in rapidly evolving ASIC landscapes.

By employing advanced SOI/MEMS technology and a dual-segment ERX/ORX structure, switch 300 illustrates a highly efficient approach to managing data traffic, catering to the high throughput and reliability standards of modern network environments. Such architecture aligns with industry trends towards integrating more intelligent and power-efficient components into network infrastructure, ensuring switch 300 remains at the forefront of network design innovation. This configuration may facilitate sustainability, adaptability, and performance.

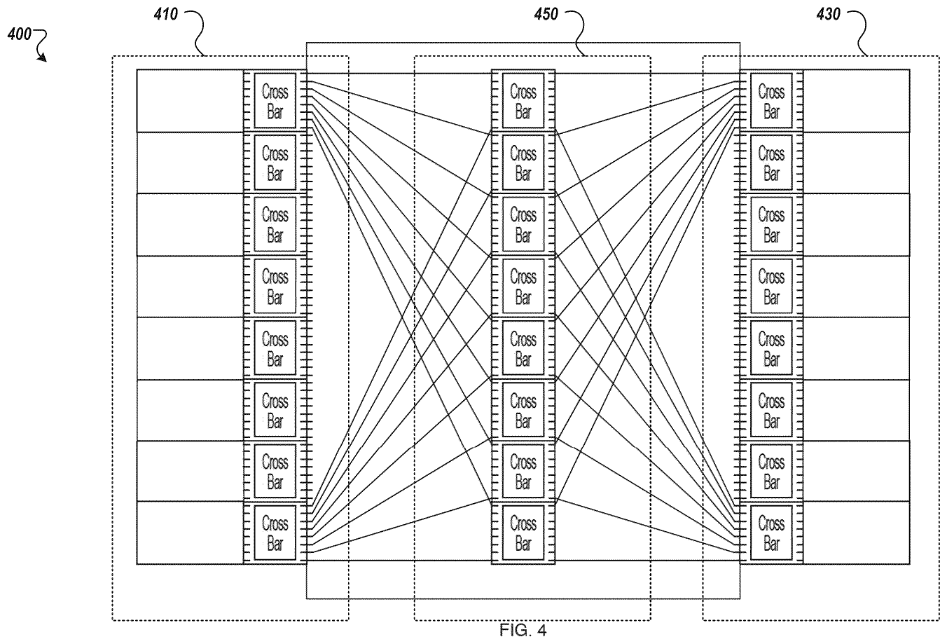

Referring now to FIG. 4, FIG. 4 depicts a switch 400. Switch 400 expands upon the previous architectures discussed above, by incorporating MEMS technology. FIG. 4 provides a visual representation of a complex switching framework that integrates multiple stages of crossbars, further detailing the segmentation between the input, middle, and output stages in accordance with some examples.

Input stage 410 and output stage 430 are shown with multiple vertical blocks, each labeled as “Cross Bar”, representing the series of crossbars at the input stage 410 and the output stage 430. The crossbars at the input stage route the incoming traffic to the middle stage 450. The crossbars may handle multiple data lines. The middle stage 450 may include a series of crossbars, which may serve to route traffic from the input stage 410 to the output stage 430. The arrangement facilitates optimal path selection and maintains the non-blocking nature of the network.

The application of MEMS technology in input/output (I/O) stages facilitates an enhancement in switch operation efficiency. MEMS components may be employed to achieve faster switching speeds, reduced power consumption, and increased reliability, addressing uses in high-performance data centers where rapid data processing and uptime may be used.

FIG. 4 shows intricate connections spanning from input crossbars to multiple middle stage crossbars and from there to output crossbars. This extensive mesh of connections underscores switch 400's capability to handle massive parallel data flows, ensuring robust data handling and redundancy.

Bidirectional data flow from the I/O stages on the input stage 410 and the output stage 430, through the middle stage 450, and out through the adjacent I/O stages, demonstrate a directional flow that supports both unidirectional and bidirectional data transmission scenarios. Switch 400 network architecture highlights the scalability used for cloud computing and large-scale data center operations. Switch 400 may adapt to different configurations and traffic demands by adjusting the number of crossbars and the specific deployment of MEMS technology. With the incorporation of MEMS, the network may handle not only high volumes of data but also support advanced features like rapid on-the-fly reconfigurations, used for dynamic cloud environments and services requiring high levels of data integrity and availability.

Switch 400 may be configured as a 6.4T switch, which may combine high throughput capabilities with low cost and power efficiency. Switch 400 architecture may integrate one or more components, including: switch element (SE) modules, power management ICs (PMICs), crystal oscillators (XTAL), a microcontroller unit (MCU), a printed circuit board (PCB), and/or a cooling fan, to achieve a robust and efficient system.

Eight SE modules may be responsible for managing data transmission and reception. The SE modules may allow the switch 400 to handle a total throughput of 6.4 terabits per second. This high capacity may be used for applications requiring rapid data processing and transfer, such as data centers and high-performance computing environments.

To support the operation of SE modules, 16 PMICs may be included to facilitate stable power delivery and efficient power management. These ICs may minimize power consumption while maintaining the performance integrity of the switch element modules. Additionally, eight crystal oscillators may be used to provide precise timing signals, which may be used for maintaining synchronization across the various components of the switch.

An MCU may be used to oversee the overall function of the switch, handling tasks such as system monitoring, performance optimization, and interfacing with external systems for management and control. This centralized control mechanism may simplify the architecture and reduce the complexity of system management. Other examples may include more than one controller in a mesh network of controllers.

Switch components may be mounted on a PCB, which offers a tailored layout to optimize signal integrity and minimize electronic noise, thereby enhancing the performance of the switch. In one example, a cooling fan may be included to manage the thermal load, ensuring that the switch operates within safe temperature limits, thereby prolonging the lifespan of the components and maintaining performance.

The cost-effectiveness of switch 400 is notable, with the total cost for the SE modules amounting to approximately $320. This cost is highly competitive, considering the advanced capabilities and high throughput of the system. The power consumption may be equally impressive, with the system consuming 56 watts. This low power may be achieved through the efficient design of the SE modules and the PMICs, as well as the strategic management of power distribution within the system.

The integration of DSPs within the SE modules may facilitate advanced data processing capabilities, such as modulation, demodulation, and error correction, directly within the optical domain. This integration allows for seamless conversion between optical and electrical signals, enhancing the speed and efficiency of data transfer. Moreover, the use of MEMS technology in switch 200 enables precise mechanical control at a microscopic scale. Such architecture is particularly beneficial for optical switching applications where fine control over optical paths is used. MEMS components contribute to the reduction in size and power consumption of the switch, while also enhancing its reliability and speed by minimizing mechanical movement.

The integration of MEMS technology at the various stages may enhance switching speed and reliability. MEMS components may contribute to lower power consumption and faster operational responsiveness, which may be used for the throughput of data centers where switch 300 may be deployed. Switch 400 may be configured to ensure a fully non-blocking architecture, allowing simultaneous, multi-directional data flows without interference. This capability may be used for applications having high data throughput and minimal latency, such as cloud computing and large-scale virtualization environments.

Switch 400 may be scaled by modifying the number of crossbars or adapting the existing configuration to support increased traffic volumes or new service standards. This modularity allows for cost-effective network expansion and maintenance without extensive downtime.

The detailed connectivity shown in the diagram ensures robust handling of data traffic, supporting advanced network management strategies like dynamic routing and load balancing. This level of control may be used for optimizing the performance of complex network architectures and can adapt to varying traffic patterns and conditions dynamically.

The network setup in switch 400 is particularly suited to data-intensive applications that use robust, fault-tolerant network infrastructure. Its ability to handle vast amounts of data with high efficiency makes it ideal for deployment in settings that cannot afford delays or data loss, such as financial services, large-scale e-commerce, and global communications networks.

Incorporating advanced MEMS technology and maintaining a flexible, scalable architecture allows switch 400 to not only meet current networking demands but also to adapt to future advancements in network technology. This foresight ensures that investments in network infrastructure remain viable and competitive in the long term, aligning with industry trends towards more integrated and intelligent network solutions.

Switch 400 may include a 6.4T switch combining extensive throughput capabilities with notable cost efficiency and minimized power consumption. Such configuration of switch 400, described in detail below, may integrate various components to meet high performance demands.

Switch 400 may use a total of 24 SE modules, which may facilitate high-speed data transfer and efficient handling of complex networking tasks. SE modules may achieve the switch's impressive throughput capability of 6.4 terabits per second, making switch 400 highly suitable for large-scale data center operations and extensive computing tasks requiring substantial data bandwidth.

Switch 400 may use 24 PMICs, which may provide stable and efficient power delivery across components. By optimizing power usage, these PMICs help to maintain the performance of the SE modules while minimizing overall energy consumption. Additionally, 24 XTALs may be included to provide precise timing signals, advantageous for maintaining the synchronization used for high-speed data transmission and processing.

Four MCUs may be strategically embedded within the system of switch 400 to oversee operational management, including task allocation, system monitoring, and error handling. These MCUs facilitate streamlined communication between the switch components, enhancing overall efficiency and reliability. The components may be assembled on a custom-designed PCB that may provide an optimal layout for reducing electronic noise and maximizing signal integrity. This careful placement may contribute to the switch's enhanced performance capabilities. A cooling fan may be integrated to dissipate heat generated by the system, thereby stabilizing the operating temperature and extending the lifespan of the components.

The total cost of the SE modules as described above may amount to approximately $960, representing a cost-effective solution given the high data throughput of the switch. The power efficiency may be a total of 168 watts. This may be achieved through the intelligent design and integration of the PMICs, which may regulate power distribution effectively across the high-performance components.

Switch 400 may use cutting-edge DSP technology within the SE modules to perform data processing tasks directly within the optical domain. This integration may allow for efficient and rapid handling of complex computations used for high-speed data transmission, reducing latency and enhancing data integrity. MEMS technology may be used to improve the precision and reliability of the optical switching mechanisms within the switch. MEMS components may facilitate fine mechanical adjustments at microscopic scales, which may be used for maintaining the accuracy and speed of optical data pathways. This technology may achieve the switch's high performance while keeping the physical footprint and power consumption low.

Switch 400 architecture may integrate advanced optical transceivers and crossbar technology to optimize network performance and scalability. For example, optical transceiver(s) may include eight receive lanes and eight transmit lanes, which may be capable of handling 100 gigabits per second. In some examples, such transceivers may include an integrated 8×8 crossbar, allowing the eight input lanes to be dynamically assigned to any of the eight output lanes, providing a flexible routing mechanism that enhances the switch's efficiency and response to network demands.

In switch 400 optical transceivers may be used in the switch architecture, where optical transceivers may be seen as a modular component of a larger, scalable network fabric. As shown, the architecture employed in switch 400 may use a three-stage configuration: an input stage 410, a middle stage 450, and an output stage 430. The stages may be populated with transceivers and crossbars, facilitating a non-blocking traffic flow across the network. Such architecture may provide a path that may be found from any input to any output, which may maintain high throughput and low latency across the network.

Switch 400 may be scaled by additional transceivers and corresponding crossbar modules that may be added as network demands increase. Such scalability may be achieved without extensive redesign or interruption of existing operations.

Because network switches may use significant power to handle electronic signal processing and may be costly to operate, switch 400 may facilitate reducing power consumption and operational costs. By leveraging the integrated crossbars within the optical transceivers, switch 400 may minimize additional electronic processing, which may reduce power consumption. This approach not only makes switch 400 eco-friendlier but also reduces operational costs, making it an attractive solution for large-scale data centers and enterprise networks.

System 400 may include storage of loss profiles via look up tables (LUTs). The optical paths through switch 400 may have a loss profile and bandwidth roll-off, which may vary depending on routing through the switch. Accordingly, switch 400 may use one or more look-up tables to store these loss profiles for the possible paths. Such storage of loss profiles via look up tables may facilitate switch 400 to recalibrate the signal processing to optimize transmission quality without real-time recalibration, which may be time-consuming and resource-intensive.

Such loss profiles provide for dynamic switch configuration features, where LUTs may facilitate switch 400 to dynamically configure routing paths. For example, when a path is switched, the corresponding coefficients from the lookup table may be instantly loaded into the system. This immediate access to the configurations may speed up the switching process and reduce latency.

Switch 400 may include one or more integrated DSP SoC (system-on-chip) integrated within the optical transceivers, which may access lookup tables to adapt the input and output configurations based on pre-stored profiles. This feature may maintain high-quality signal integrity across the switch without the need for extensive manual adjustments when the network configuration changes.

The middle stage 450 (e.g., a central crossbar switch) may be housed within the SoC to facilitate direct communication between the one or more DSPs without using additional routing. In some examples, the one or more PMDs or the one or more DSPs may be embedded within a single chip to facilitate increased signal integrity when compared to a baseline (e.g., when a single chip is not used). In some examples, the one or more PMDs or the one or more DSPs may be embedded within a single chip to facilitate reduced latency when compared to a baseline (e.g., when a single chip is not used).

The ability to quickly reconfigure the network based on pre-stored settings in the lookup table may be used in environments where network conditions can change rapidly. This rapid adaptability ensures that network performance remains optimal even as different nodes and paths are activated or deactivated. The lookup table, as a component of switch 200, 300, may facilitate efficient management and switch optical signals with minimal latency and power usage while maintaining high data integrity and throughput.

The lookup table may include one or more optimized routing paths or signal quality metrics. The lookup table may be able to optimize for one or more of performance or energy efficiency.

Integration of optical transceivers that include an 8×8 crossbar may route signals flexibly within the transceiver, optimizing both input and output paths. The use of crossbars, both active and passive, is discussed. The technology leverages these crossbars to facilitate the switching of signals within the network infrastructure. The active crossbars may be embedded within the DSP chips, and passive crossbars, possibly implemented with MEMS technology, can reduce latency and power consumption.

A CMOS protocol for managing the switch configurations may be used in the synchronization and management of the multiple DSP chips and crossbars within the network, ensuring that the switching operations may be coherent and do not interfere with one another. Moreover, the integration of MEMS technology in passive crossbars may provide a low-power solution that may not compromise on switching speed or reliability.

Switch 400 may include packet inspection and queuing mechanisms. For example, integration of packet inspection and queuing mechanisms within the switch architecture may facilitate sophisticated network management capabilities, adapting to various network demands and conditions.

Some examples include methods of fabrication and calibration corresponding to switch 400. For example, when configuring the DSPs and crossbars to specific loss profiles during manufacture a pre-calibration method may facilitate fast deployment and reconfiguration of the network once in operation. The use of lookup tables for storing loss profiles for the pathways in the switch may allow for rapid reconfiguration of the switch's pathways without needing recalibration, facilitating quick adaptations to changes in network traffic. Switch 400 may include calibration manager (not shown) embedded into the SoC.

In some examples, switch 400 may adjust configurations based on real-time data. This may include the potential use of feedback paths to adjust the settings on transmitters based on the received signals, enhancing the adaptability of the system. Switch 400 may include static and/or quasi-static routing paths.

Static routing paths may be fixed, predetermined paths that do not change unless manually reconfigured. This configuration may provide a reliable and predictable network behavior, helpful to facilitate path predictability and minimal latency. Static routing may be simple to implement and maintain but may lack flexibility in adapting to network changes, such as congestion or link failure. On the other hand, quasi-static routing paths may offer a middle ground between static and dynamic routing. Quasi-static paths may be periodically updated to optimize network performance or respond to changes in the network environment. These updates may not be as frequent as those in dynamic routing, making quasi-static useful for networks where occasional adjustments are to be facilitated without the overhead of continuous route calculation.

Crossbars of switch 400 architecture, which enable data to be routed between inputs and outputs directly may be implemented using semiconductor processes, which may allow for high-speed, reliable operations that may be used for large-scale integration in electronic devices.

Switch 400 crossbars may be constructed using MEMS, which may offer the advantages of physical flexibility and potentially lower power consumption. MEMS technology may allow for physically reconfigurable paths, providing robustness against physical failures and adaptability in network topology. Some examples may include electromechanical assemblies, for example, in environments where robust mechanical operations may be used over purely electronic solutions. Switch 400 crossbars may include a DSP architecture, which may allow for enhanced data handling capabilities, such as signal conditioning and error correction, directly within the switch, facilitating complex routing decisions and improving overall network efficiency.

Input and output of switches may not be exclusively optical. For example, switch 400 may be connected to the network via active electrical cables. Such cables, equipped with DSPs, may be used for high-speed electrical signals with sophisticated signal processing techniques to maintain signal integrity.

Switch 400 may implement utilization of DSPs in active electrical cables for facilitating advanced functionalities including signal amplification, noise filtering, and error checking, which may maintain high data integrity and speed over electrical interfaces. Such adaptability may make DSP-based electrical I/O practical for a wide range of applications, providing a flexible and cost-effective alternative to optical connections, e.g., in environments where optical deployment is constrained by cost or infrastructure limitations.

Some examples may include equalization in switches, for example by, incorporating equalization techniques such as Continuous Time Linear Equalization (CTLE) within a switch architecture. Equalization techniques may reduce signal degradation over transmission paths. Inputs and outputs of the switch may use dedicated equalization settings to compensate for losses and intersymbol interference, which may be common in high-speed data channels. Such approach may maintain signal quality across various transmission mediums, either electrical or optical.

Equalization settings may be dynamically adjusted based on the channel conditions, which may optimize performance and ensure reliable data transmission. By implementing equalization directly at the inputs and outputs of the switch, switch 400 may effectively handle a wide range of signal impairments, leading to improved data integrity and a reduction in error rates across the network. In some examples, one or more of the input or the output may use equalization to facilitate increased data integrity and reduced error rates when compared to a baseline (e.g., a baseline in which equalization is not used).

LUTs of switch 400 may be housed within a control unit of switch 400. LUTs may be embedded within the middle crossbar. Such LUTs may be stored in this manner irrespective of whether the crossbar utilizes DSP technology or other forms of implementation discussed above (e.g., MEMS or semiconductor processes). Positioning LUTs in the middle crossbar may speed up routing decisions, as the data may be available directly at the routing core. Such configuration may enhance the switch's 400 responsiveness to changing network conditions and reduce the latency typically associated with routing decisions. For crossbars not based on DSPs, integrating lookup tables may ensure that these tables can be quickly and efficiently accessed, providing a seamless flow of data across the switch. This setup may be used in complex network environments where rapid reconfiguration of routing paths is frequently used to optimize traffic flow and network performance. In some examples, one or more DSPs across different stages may access the lookup table to coordinate configuration of the one or more crossbar switches.

Integration and utility of physical layer devices (such as optical transceivers with built-in DSPs) within the networks may include the integration of Ethernet and CMOS-based controls for managing the configurations within the network. CMOS integration may allow for easier management of network components and better synchronization across various parts of the switch. By using optical rather than electronic switching where possible, one or more examples herein may leverage use of passive devices and MEMS technology in the switch architecture for reducing power consumption while maintaining high performance. In one example, a network protocol may control, via an external command (e.g., which may be received through an Ethernet connection), one or more of: an operation of the one or more crossbar switches, or an updating of the lookup table.

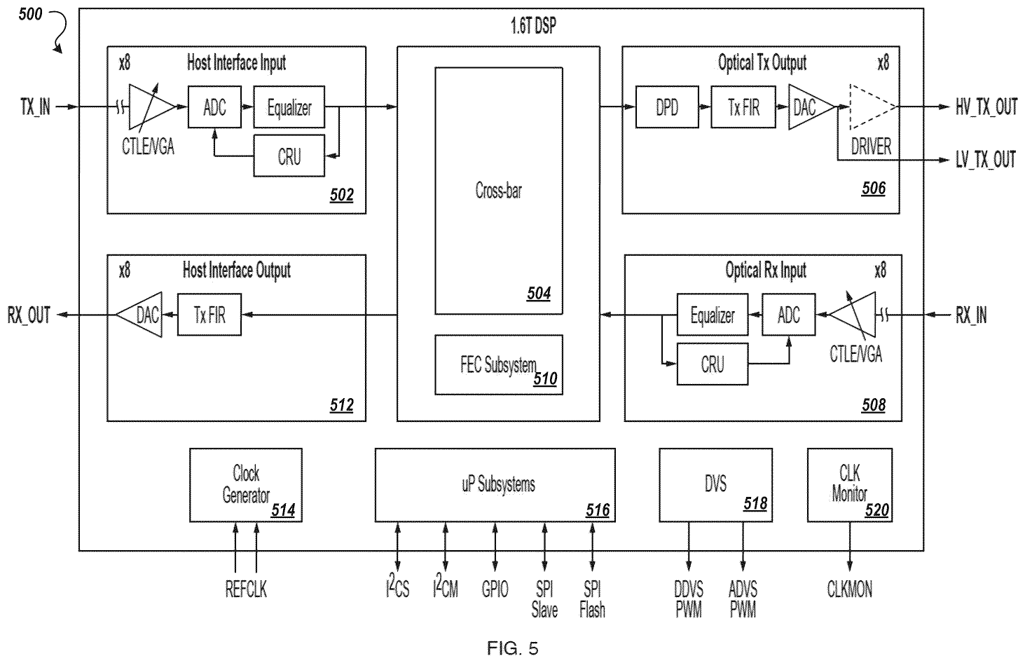

FIG. 5 illustrates an example DSP 500 that may be used with the switch 400 (as illustrated in FIG. 4). The DSP 500 may include various components such as a host interface input 502, a cross-bar 504, an optical transmit (Tx) output 506, an optical receive (Rx) input 508, an forward error correction (FEC) subsystem 510, a host interface output 512, a clock generator 514, a microcontroller (uP) subsystem 516, dynamic voltage scaling (DVS) 518, a clock (CLK) monitor 520, or the like.

The host interface input 502 may receive a Tx-IN signal. The host interface input 502 may include a CTLE/VGA, an analog to digital converter (ADC), an equalizer, a clock recovery unit, or the like. The host interface input may be coupled to the cross-bar 504 and/or the FEC subsystem 510. The cross-bar 504 and/or FEC subsystem 510 may provide a signal to the optical Tx output 506, which may include a digital pre-distorter (DPD), a Tx finite impulse response (FIR), a digital to analog converter (DAC), a driver, or the like. The signal from the optical Tx output 506 may be a high voltage transmission out (HV-TX-OUT) or a low voltage transmission out (LV-TX-OUT).

The optical Rx input 508 may receiver an RX-IN signal. The optical Rx input 508 may include a CTLE/variable gain amplifier (VGA), an ADC, an equalizer, a clock recovery unit, or the like. The signal from the optical Rx input 508 may be directed to the cross-bar 504 and/or the FEC subsystem 510. The signal from the cross-bar 504 and/or FEC subsystem 510 may be directed to the host interface output 512, which may include a Tx FIR, a DAC, or the like.

The remaining components of the DSP 500 may have various functionality. The clock generator 514 may receive a REFCLK signal. The uP subsystems may interface using one or more of inter-integrated circuit slave (I²CS), inter-integrated circuit master (I²CM), general purpose input/output (GPIO), serial peripheral interface (SPI) Slave, SPI Flash, or the like. DVS 518 may send digital DVS pulse width modulation (PWM) and/or analog DVS PWM. The CLK monitor 520 may send a clock monitor (CLKMON) signal.

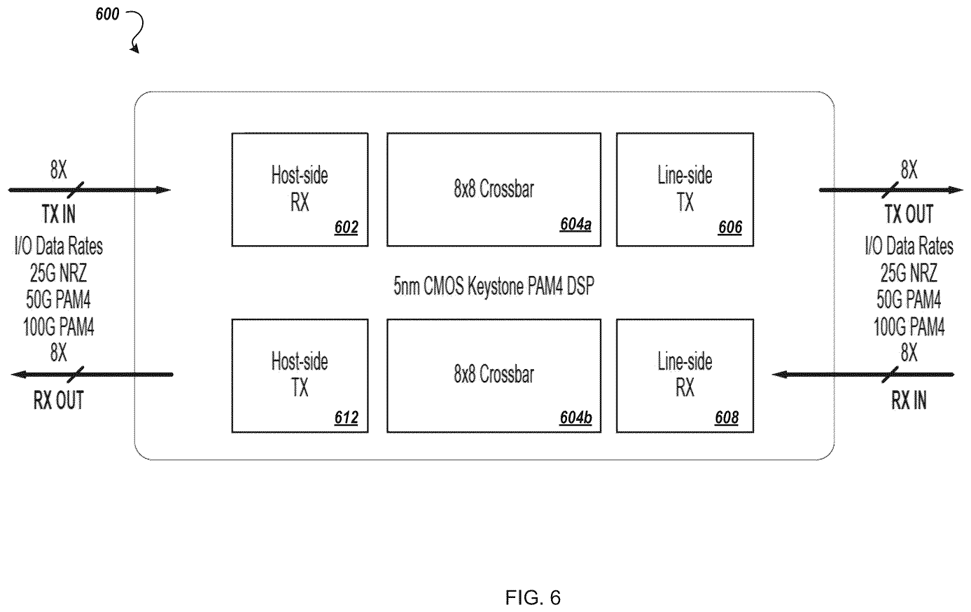

FIG. 6 illustrates a block diagram of a DSP 600. The DSP 600 may include a host-side Rx 602, an 8×8 crossbar 604a and 8×8 crossbar 604b, a line-side TX 606, a line-side Rx 608, a host-side TX 612, or the like. The DSP 600 may receive a TX IN. The TX IN may have various input/output data rates such as: (a) 25G when using non-return to zero (NRZ), (b) 50G when using pulse amplitude modulation 4 (PAM4), or (c) 100G when using PAM4. The host-side Rx 602 may direct the signal to the 8×8 crossbar 604a. The 8×8 crossbar 604a may direct the signal to the line-side TX 606 where the signal may be sent out as TX OUT. TX OUT may have various input/output data rates such as: (a) 25G when using NRZ, (b) 50G when using PAM4, or (c) 100 G when using PAM4.

The DSP 600 may receive an RX IN. The RX IN may have various input/output data rates such as: (a) 25G when using NRZ, (b) 50G when using PAM4, or (c) 100G when using PAM4. The line-side Rx 608 may direct the signal to the 8×8 crossbar 604b. The 8×8 crossbar 604b may direct the signal to the host-side TX 612 where the signal may be sent out as RX OUT. RX OUT may have various input/output data rates such as: (a) 25G when using NRZ, (b) 50G when using PAM4, or (c) 100G when using PAM4.

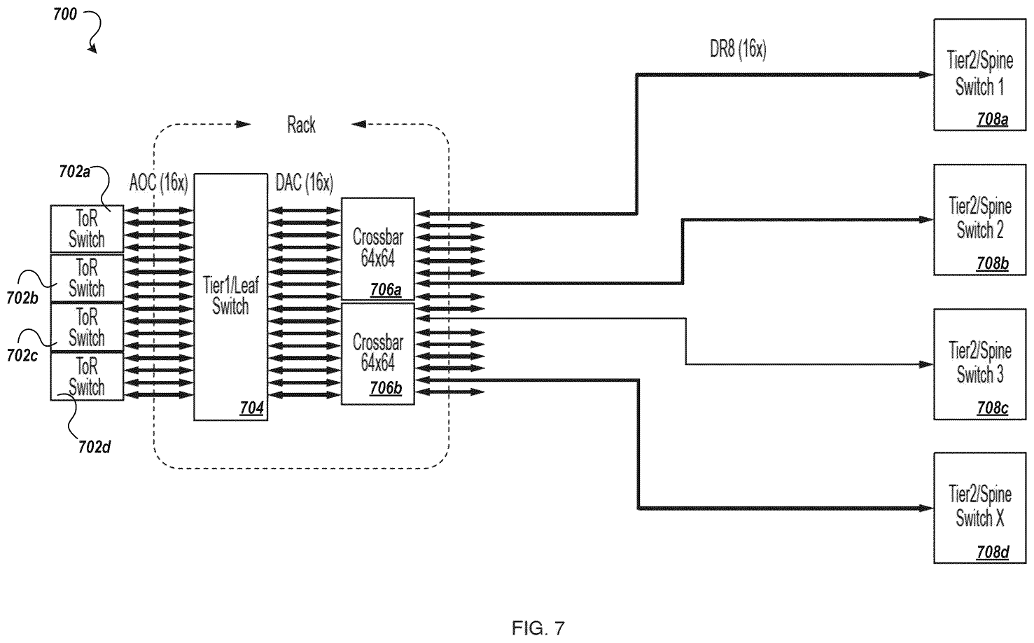

FIG. 7 illustrates a schematic 700 showing connectivity between top of rack (ToR) switches 702a, 702b, 702c, 702d and tier2/spine switches 708a, 708b, 708c, 708c, 708d. The TOR switches 702a, 702b, 702c, 702d may be connected to a tier1/leaf switch 704 using an active optical connection (AOC). The tier1/leaf switch 704 may be connected to crossbar 64×64 706a and crossbar 64×64 706b using a direct attach cable. The crossbar 64×64 706a and crossbar 64×64 706b may be connected to the tier2/spine switches 708a, 708b, 708c, 708d. The schematic 700 may provide for low reconfiguration latency (e.g., less than 1 second) and low transit latency (e.g., less than 500 nanoseconds).

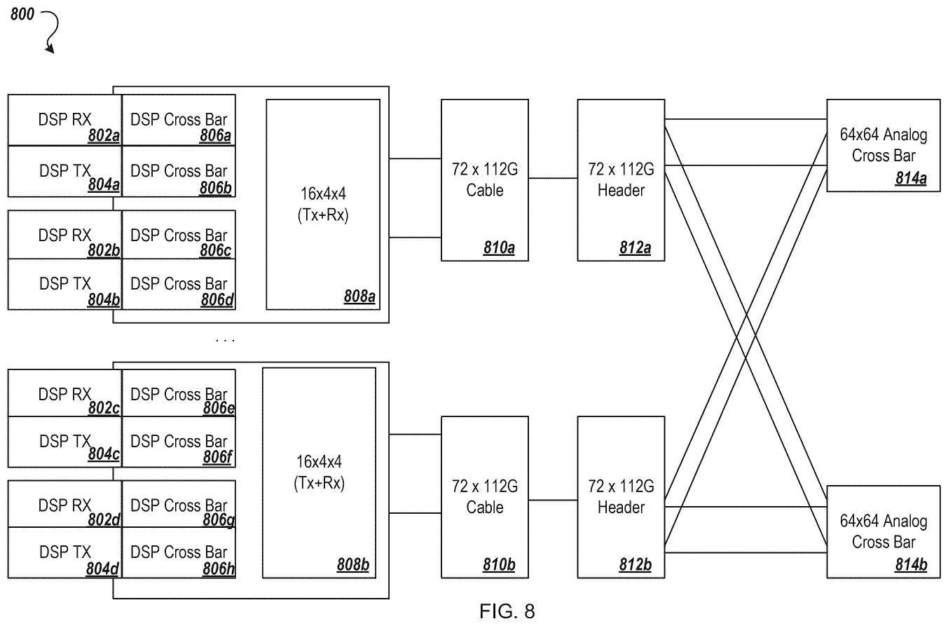

FIG. 8 shows example architecture 800 for a switch with radix expansion. The architecture 800 may include various DSP RXs 802a, 802b, 802c, 802d which may be coupled to DSP crossbars 806a, 806c, 806e, 806g. The architecture 800 may include various DSPs TXs 804a, 804b, 804c, 804d which may be coupled to DSP crossbars 806b, 806d, 806f, 806h. The DSP crossbars 806a to 806h may be coupled to 16×4×4 analog crossbars 808a, 808b. By including the 16×4×4 analog crossbars 808a, 808b, the radix may be increased. For example, 64 and 128 radix may be facilitated. Thus, the architecture may include one or more additional crossbars (e.g., 16×4×4 analog crossbars 808a, 808b) that may facilitate radix expansion by connecting the one or more crossbar switches (e.g., DSP crossbars 806a to 806h) to a central crossbar (e.g., 64×64 analog crossbars 814a, 814b).

The 16×4×4 analog crossbars 808a, 808b may be coupled to 72×112G cables (e.g., Samtec ExaMax®) 810a, 810b. The 72×112G cables 810a, 810b may be coupled to 72×112G headers 812a, 812b. The 72×112G headers 812a, 812b may be coupled to 64×64 analog crossbars 814a, 814b.

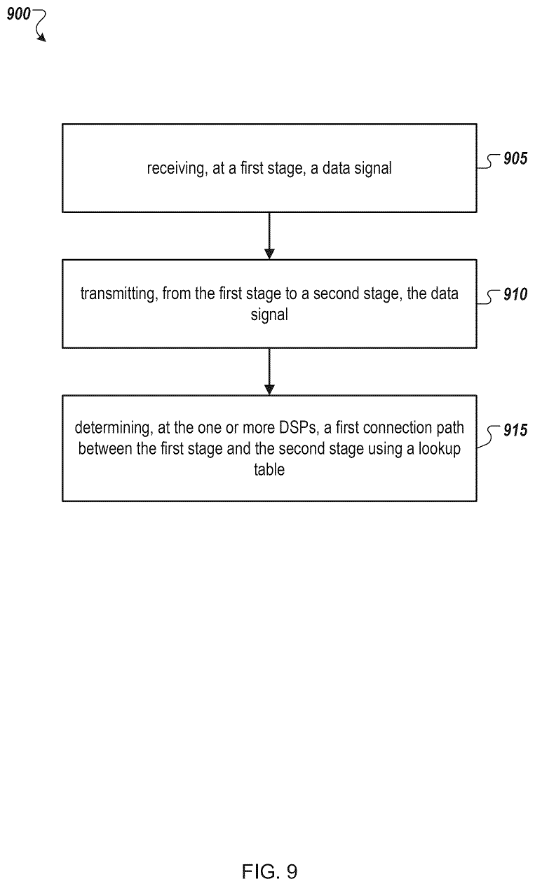

FIG. 9 illustrates a process flow of an example method 900, in accordance with at least one example described in the present disclosure. The method 900 may be arranged in accordance with at least one example described in the present disclosure.

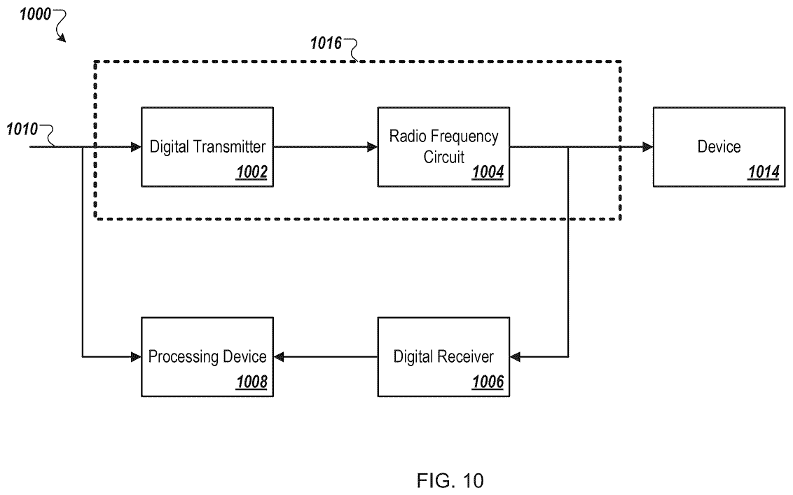

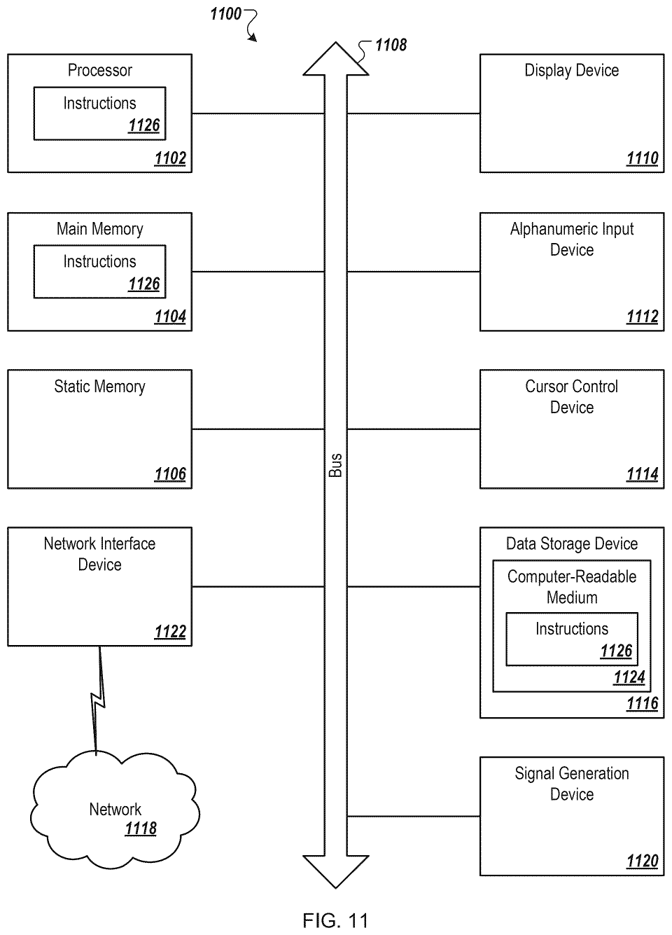

The method 900 may be performed by processing logic that may include hardware (circuitry, dedicated logic, etc.), software (such as is run on a computer system or a dedicated machine), or a combination of both, which processing logic may be included in the processing device 1102 of FIG. 11, the communication system 1000 of FIG. 10, or another device, combination of devices, or systems.

The method 900 may begin at block 905 where the processing logic may receive, at a first stage, a data signal, in which the first stage includes one or more PMD devices comprising one or more DSPs that operate a first set of one or more crossbar switches.

At block 910, the processing logic may transmit, from the first stage to a second stage, the data signal, in which the first stage is operatively connected to the second stage via the first set of one or more crossbar switches.

At block 915, the processing logic may determine, at the one or more DSPs, a first connection path between the first stage and the second stage using a lookup table.

The processing logic may transmit, from the second stage to a third stage, the data signal, in which the second stage is operatively connected to the third stage via a second set of one or more crossbar switches; and determine, at the one or more DSPs, a second connection path between the second stage and the third stage using the lookup table.

The processing logic may facilitate a non-blocking path between the first stage and the third stage. The processing logic may connect the first stage to one or more additional crossbars to facilitate radix expansion. The processing logic may dynamically reconfigure the connection path between the first stage and the second stage based on data stored in the lookup table to optimize data transmission across the first stage and the second stage. The processing logic may update the lookup table in real-time based on one or more of a change in a network condition or a change in a network configuration. The processing logic may calculate, at the one or more DSPs, an optimal data path between the first stage and the second stage based on a comparison of a current network condition to a stored profile in the lookup table.

The processing logic may use a passive crossbar switch within the first stage or the second stage to one or more of reduce power consumption or reduce latency when compared to a baseline measured using an active switching component, wherein the passive crossbar uses MEMS to connect the input and the output.

In some examples, the first set of one or more crossbar switches may include one or more of an 8×8 crossbar switch or a 64×64 crossbar switch. In some examples, the lookup table may include one or more of a pre-calculated loss profile or a bandwidth roll-off characteristic for the first connection path between the first stage and the second stage.

The processing logic may adjust a configuration of the one or more crossbar switches in response to detected packet transmission to maintain a quality of service.

Modifications, additions, or omissions may be made to the method 900 without departing from the scope of the present disclosure. For example, in some examples, the method 900 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 10 illustrates a block diagram of an example communication system 1000, in accordance with at least one example described in the present disclosure. The communication system 1000 may include a digital transmitter 1002, a radio frequency circuit 1004, a device 1014, a digital receiver 1006, and a processing device 1008. The digital transmitter 1002 and the processing device may receive a baseband signal via connection 1010. A transceiver 1016 may include the digital transmitter 1002 and the radio frequency circuit 1004.

In some examples, the communication system 1000 may include a system of devices that may communicate with one another via a wired or wireline connection. For example, a wired connection in the communication system 1000 may include one or more Ethernet cables, one or more fiber-optic cables, and/or other similar wired communication mediums. Alternatively, or additionally, the communication system 1000 may include a system of devices that may communicate via one or more wireless connections. For example, the communication system 1000 may include one or more devices that may transmit and/or receive radio waves, microwaves, ultrasonic waves, optical waves, electromagnetic induction, and/or similar wireless communications. Alternatively, or additionally, the communication system 1000 may include combinations of wireless and/or wired connections. In these and other examples, the communication system 1000 may include one or more devices that may obtain a baseband signal, perform one or more operations to the baseband signal to generate a modified baseband signal, and transmit the modified baseband signal, such as to one or more loads.

In some examples, the communication system 1000 may include one or more communication channels that may communicatively couple systems and/or devices included in the communication system 1000. For example, the transceiver 1016 may be communicatively coupled to the device 1014.

In some examples, the transceiver 1016 may obtain a baseband signal. For example, as described herein, the transceiver 1016 may generate a baseband signal and/or receive a baseband signal from another device. In some examples, the transceiver 1016 may transmit the baseband signal. For example, upon obtaining the baseband signal, the transceiver 1016 may transmit the baseband signal to a separate device, such as the device 1014. Alternatively, or additionally, the transceiver 1016 may modify, condition, and/or transform the baseband signal in advance of transmitting the baseband signal. For example, the transceiver 1016 may include a quadrature up-converter and/or a DAC that may modify the baseband signal. Alternatively, or additionally, the transceiver 1016 may include a direct radio frequency (RF) sampling converter that may modify the baseband signal.

In some examples, the digital transmitter 1002 may obtain a baseband signal via connection 1010. In some examples, the digital transmitter 1002 may up-convert the baseband signal. For example, the digital transmitter 1002 may include a quadrature up-converter to apply to the baseband signal. In some examples, the digital transmitter 1002 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 1002.

In some examples, the transceiver 1016 may include one or more subcomponents that may be used in preparing the baseband signal and/or transmitting the baseband signal. For example, the transceiver 1016 may include an RF front end (e.g., in a wireless environment) which may include a power amplifier (PA), a digital transmitter (e.g., 1002), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1004) of the transceiver 1016 may be synchronized with the resource controller via the S-plane device, which may contribute to high-accuracy timing with respect to a reference clock.

In some examples, the transceiver 1016 may obtain the baseband signal for transmission. For example, the transceiver 1016 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1016 may generate a baseband signal for transmission. In these and other examples, the transceiver 1016 may transmit the baseband signal to another device, such as the device 1014.

In some examples, the device 1014 may receive a transmission from the transceiver 1016. For example, the transceiver 1016 may transmit a baseband signal to the device 1014.

In some examples, the radio frequency circuit 1004 may transmit the digital signal received from the digital transmitter 1002. In some examples, the radio frequency circuit 1004 may transmit the digital signal to the device 1014 and/or the digital receiver 1006. In some examples, the digital receiver 1006 may receive a digital signal from the RF circuit and/or send a digital signal to the processing device 1008.

In some examples, the processing device 1008 may be a standalone device or system, as illustrated. Alternatively, or additionally, the processing device 1008 may be a component of another device and/or system. For example, in some examples, the processing device 1008 may be included in the transceiver 1016. In instances in which the processing device 1008 is a standalone device or system, the processing device 1008 may communicate with additional devices and/or systems remote from the processing device 1008, such as the transceiver 1016 and/or the device 1014. For example, the processing device 1008 may send and/or receive transmissions from the transceiver 1016 and/or the device 1014. In some examples, the processing device 1008 may be combined with other elements of the communication system 1000.

FIG. 11 illustrates a diagrammatic representation of a machine in the example form of a computing device 1100 within which a set of instructions, for causing the machine to perform any one or more of the methods discussed herein, may be executed. The computing device 1100 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1100 includes a processing device (e.g., a processor 1102), a main memory 1104 (e.g., read-only memory (ROM), flash memory, dynamic random access memory (DRAM) such as synchronous DRAM (SDRAM)), a static memory 1106 (e.g., flash memory, static random access memory (SRAM)) and a data storage device 1116, which communicate with each other via a bus 1108.

Processing device 1102 represents one or more general-purpose processing devices such as a microprocessor, central processing unit, or the like. More particularly, the processing device 1102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also include one or more special-purpose processing devices such as an application specific integrated circuit (ASIC), a field programmable gate array (FPGA), a DSP, network processor, or the like. The processing device 1102 is configured to execute instructions 1126 for performing the operations and steps discussed herein.

The computing device 1100 may further include a network interface device 1122 which may communicate with a network 1118. The computing device 1100 also may include a display device 1110 (e.g., a liquid crystal display (LCD) or a cathode ray tube (CRT)), an alphanumeric input device 1112 (e.g., a keyboard), a cursor control device 1114 (e.g., a mouse) and a signal generation device 1120 (e.g., a speaker). In at least one example, the display device 1110, the alphanumeric input device 1112, and the cursor control device 1114 may be combined into a single component or device (e.g., an LCD touch screen).

The data storage device 1116 may include a computer-readable storage medium 1124 on which is stored one or more sets of instructions 1126 embodying any one or more of the methods or functions described herein. The instructions 1126 may also reside, completely or at least partially, within the main memory 1104 and/or within the processing device 1102 during execution thereof by the computing device 1100, the main memory 1104 and the processing device 1102 also constituting computer-readable media. The instructions may further be transmitted or received over a network 1118 via the network interface device 1122.

While the computer-readable storage medium 1124 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

In one example, a system for a self-contained network switching system may include: a system-on-chip (SoC) architecture integrating multiple optical transceivers and their associated DSPs, each DSP capable of operating an 8×8 crossbar switch, in which the optical transceivers and DSPs are embedded within a single chip to enhance signal integrity and reduce latency; a centralized SoC module configured to function as both the input and output stage, with each stage including a set of the integrated optical transceivers connected directly to the DSPs without external interfacing; a built-in central crossbar switch housed within the same SoC module, facilitating direct communication between the integrated DSPs to manage data flow across the system without additional routing hardware; and/or a control unit embedded within the SoC, programmed to manage the configuration of the crossbar switches based on a comprehensive lookup table stored within the SoC, which contains optimized routing paths and signal quality metrics; in which the lookup table provides real-time dynamic configuration of the system's data routing, optimizing for both performance and energy efficiency by leveraging the close integration of components within the SoC architecture.

In another example, a system for a self-contained network switch may include system-on-chip (SoC) architecture integrating multiple optical transceivers and associated DSPs, each DSP capable of operating an 8×8 crossbar switch, in which the optical transceivers and DSPs are embedded within a single chip to enhance signal integrity and reduce latency.

In another example, the system may further include a centralized SoC module configured to function as both the input and output stage, with each stage including a set of the integrated optical transceivers connected directly to the DSPs without external interfacing.

In another example, the system may further include a built-in central crossbar switch housed within the same SoC module, facilitating direct communication between the integrated DSPs to manage data flow across the system without the need for additional routing hardware.

In another example, the system may further include a control unit embedded within the SoC, programmed to manage the configuration of the crossbar switches based on a comprehensive lookup table stored within the SoC, which contains optimized routing paths and signal quality metrics specifically tailored for a self-contained architecture, in which the lookup table enables real-time dynamic configuration of the system's data routing, optimizing for both performance and energy efficiency by leveraging the close integration of components within the SoC architecture.

In another example, a method for managing data transmission in a network switch may include: receiving a data signal at a first stage comprising a plurality of transceivers, each transceiver including an integrated DSP capable of operating an 8×8 crossbar switch; transmitting the data signal through a configurable network of stages, each stage operatively connected to at least one other stage via an 8×8 crossbar switch; determining connection paths between said stages using a central lookup table stored within each DSP, in which the lookup table includes pre-calculated loss profiles and bandwidth roll-off characteristics for each potential connection path within the network switch.

In another example, the method may include dynamically reconfiguring the connection paths based on the data stored in the lookup table to optimize data transmission across the network switch.

In another example, the lookup table may be updated in real-time based on changes in network conditions or configurations.

In another example, the lookup table may include information regarding optical impairments associated with each potential connection path.

In another example, DSPs in the transceiver may calculate the optimal data paths through the network switch based on a comparison of current network conditions to the stored profiles in the lookup table.

In another example, a passive crossbar switch within one or more of the stages may reduce power consumption and latency compared to active switching components.

In another example, the passive crossbar switch may utilize MEMS for establishing connections between input and output lanes.

In another example, the method may include adjusting the configuration of the crossbar switches in response to detected packet transmission standards to maintain quality of service.

In another example, the central lookup table may be configured to be accessed by multiple DSPs across different stages simultaneously to coordinate the switch configuration in a unified manner.

In another example, the configuration of the network switch may be managed via a network protocol, such as CMOS protocol, that controls the operation of the crossbar switches and the updating of the lookup table based on external commands received through an Ethernet connection.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A system, comprising:
a system-on-chip (SoC) comprising one or more physical media dependent (PMD) devices, wherein the one or more PMD devices are associated with one or more digital signal processors (DSPs), wherein the one or more DSPs operate one or more crossbar switches;
a central crossbar switch facilitating communication between the one or more DSPs; and
a control unit operable to manage a configuration of the one or more crossbar switches based on a lookup table, wherein the lookup table facilitates data routing between an input and an output.

2. The system of claim 1, wherein the central crossbar switch is operable to facilitate a non-blocking path between the input and the output.

3. The system of claim 1, wherein the central crossbar switch is housed within the SoC to facilitate direct communication between the one or more DSPs without using additional routing.

4. The system of claim 1, further comprising one or more additional crossbars operable to facilitate radix expansion by connecting the one or more crossbar switches to the central crossbar.

5. The system of claim 1, further comprising:
one or more of an input stage or an output stage including the one or more PMD devices connected directly to the one or more DSPs without external interfacing.

6. The system of claim 1, wherein:
the lookup table includes one or more of optimized routing paths or signal quality metrics; or
the lookup table is operable to optimize for one or more of performance or energy efficiency.

7. The system of claim 1, wherein the one or more crossbar switches comprises one or more of an 8×8 crossbar switch or a 64×64 crossbar switch.

8. The system of claim 1, wherein the one or more PMDs and the one or more DSPs are embedded within a single chip to facilitate increased signal integrity and reduced latency when compared to a baseline.

9. The system of claim 1, further comprising one or more passive crossbars using microelectromechanical systems (MEMS) to facilitate reduced power when compared to a baseline.

10. The system of claim 1, further comprising one or more of a switch element, a power management integrated circuit, a crystal oscillator, a microcontroller unit, a printed circuit board, or a cooling fan.

11. The system of claim 1, further comprising one or more of a static routing path or a quasi-static routing path.

12. The system of claim 1, wherein one or more of the input or the output uses equalization to facilitate increased data integrity and reduced error rates when compared to a baseline.

13. The system of claim 1, wherein the lookup table is accessible by a plurality of DSPs across different stages to coordinate configuration of the one or more crossbar switches.

14. The system of claim 1, wherein a network protocol is operable to control, via an external command received through an Ethernet connection, one or more of: an operation of the one or more crossbar switches, or an updating of the lookup table.

15. A method, comprising:
receiving, at a first stage, a data signal, wherein the first stage comprises one or more physical media dependent (PMD) devices comprising one or more digital signal processors (DSPs) that operate a first set of one or more crossbar switches;
transmitting, from the first stage to a second stage, the data signal, wherein the first stage is operatively connected to the second stage via the first set of one or more crossbar switches; and
determining, at the one or more DSPs, a first connection path between the first stage and the second stage using a lookup table.

16. The method of claim 15, further comprising:
transmitting, from the second stage to a third stage, the data signal, wherein the second stage is operatively connected to the third stage via a second set of one or more crossbar switches; and
determining, at the one or more DSPs, a second connection path between the second stage and the third stage using the lookup table.

17. The method of claim 16, further comprising facilitating a non-blocking path between the first stage and the third stage.

18. The method of claim 15, further comprising connecting the first stage to one or more additional crossbars to facilitate radix expansion.

19. The method of claim 15, wherein the first set of one or more crossbar switches comprises one or more of an 8×8 crossbar switch or a 64×64 crossbar switch.

20. The method of claim 15, wherein the lookup table includes one or more of a pre-calculated loss profile or a bandwidth roll-off characteristic for the first connection path between the first stage and the second stage.

21. The method of claim 15, further comprising dynamically reconfiguring the connection path between the first stage and the second stage based on data stored in the lookup table to optimize data transmission across the first stage and the second stage.

22. The method of claim 15, further comprising:
updating the lookup table in real-time based on one or more of a change in a network condition or a change in a network configuration.

23. The method of claim 15, further comprising calculating, at the one or more DSPs, an optimal data path between the first stage and the second stage based on a comparison of a current network condition to a stored profile in the lookup table.

24. The method of claim 15, further comprising using a passive crossbar switch within the first stage or the second stage to one or more of reduce power consumption or reduce latency when compared to a baseline measured using an active switching component, wherein the passive crossbar uses microelectromechanical systems (MEMS) to connect the input and the output.

25. The method of claim 15, further comprising adjusting a configuration of the one or more crossbar switches in response to detected packet transmission to maintain a quality of service.
